(19) United States
(12) Patent Application Publication
(10) Pub. No.: US 2007/0212055 A1
(43) Pub. Date: Sep. 13, 2007

(54) IMAGE CAPTURE APPARATUS

(76) Inventor: Akihiro YOSHIDA, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/677,718

(22) Filed: Feb. 22, 2007

(30) Foreign Application Priority Data
Mar. 10, 2006 (JP) 2006-066446
Nov. 30, 2006 (JP) 2006-324923

(51) Int. Cl. G03B 7/095; G03B 7/085

(52) U.S. Cl. 396/257

(57) ABSTRACT

An image capture apparatus is disclosed that includes an aperture having an adjustable aperture value, an image capturing element, and a drive unit that drives the image capturing element to operate in video image capturing mode and still image capturing mode. The aperture has at least a dedicated aperture value for the still image capturing mode or a dedicated aperture value for the video image capturing mode.

### BACKGROUND OF THE INVENTION

1. Field of the Invention

The present invention relates to an image capture apparatus.

2. Description of the Related Art

CCD technology for VGA-size video imaging at 30 frames per second are expected to be widely implemented in future applications. It is noted that although techniques related to pixel decimation and pixel addition in the vertical direction are conventionally known, a technique for reducing the resolution in the horizontal direction has not yet been developed.

In the field of digital still cameras, there is a growing trend toward increasing the pixel number of captured images, and owing to the development of techniques for pixel addition in the horizontal direction, recording of high resolution video images in VGA-size (640×480 pixels) at a high frame rate of 30 frames per second is becoming possible.

In operations for such video imaging, pixel mixing in the horizontal direction is performed, and thereby, sensitivity of the image capturing element may have to be set higher than that for conventional operations. Specifically, although pixel mixing has generally been limited to two-pixel mixing in conventional operations, four-pixel mixing (vertical/horizontal two-pixel mixing), six-pixel mixing (vertical two-pixel mixing/horizontal three-pixel mixing or vertical three-pixel mixing/horizontal two-pixel mixing), or nine-pixel mixing (vertical/horizontal three-pixel mixing) may be performed in operations for high-resolution high-frame-rate video imaging as is described above. In turn, the sensitivity of the image capturing element may be set 2-4.5 times higher than a standard sensitivity.

When the pixel mixing operations for high-resolution high-frame-rate video imaging is performed through conventional control operations, problems such as white-out (saturation of the image capturing element output) may easily occur due to increased cases of smearing as a result of increased shutter speed and limitations in exposure adjustment for subjects with high brightness such as outdoor subjects. Also, it is noted that technology for reducing the cell size of the CCD is rapidly developing, and the degradation of absolute smear characteristics of the CCD resulting from such size reduction has to be taken into consideration.

Accordingly, there is a demand for a technique for reducing smears and preventing white-out in an image capture apparatus.

### SUMMARY OF THE INVENTION

According to an embodiment of the present invention, an image capture apparatus is provided that includes:

an aperture having an adjustable aperture value;

an image capturing element; and

a drive unit that drives the image capturing element to operate in video image capturing mode and still image capturing mode; wherein

the aperture has at least one of a dedicated aperture value for the still image capturing mode and a dedicated aperture value for the video image capturing mode.

In one preferred embodiment, the dedicated aperture value for the video image capturing mode is greater than an aperture value used in the still image capturing mode.

In another preferred embodiment, a video mode aperture value range that includes the dedicated aperture value for the video image capturing mode is used when capturing a video image with a pixel size greater than or equal to a predetermine pixel size at a frame rate greater than or equal to a predetermined frame rate, the video mode aperture value range being greater than a still image mode aperture value range used in the still image capturing mode.

In another preferred embodiment, the image capture apparatus of the present embodiment further includes a determination unit that determines a drive mode, wherein an aperture value range to be used is changed according to the determined drive mode.

According to another embodiment of the present invention, an image capture apparatus is provided that includes:

an aperture having an adjustable aperture value;

an image capturing element; and

a drive unit that drives the image capturing element to operate in pixel mixing mode and non pixel mixing mode;

wherein

the aperture has at least one of a dedicated aperture value for the pixel mixing mode and a dedicated aperture value for the non pixel mixing mode.

In one preferred embodiment, the dedicated aperture value for the pixel mixing mode is greater than an aperture value used in the non pixel mixing mode.

In another preferred embodiment, a pixel mixing mode aperture value range that includes the dedicated aperture value for the pixel mixing mode is used when pixel mixing at a pixel number greater than or equal to a predetermined pixel number is performed, the pixel mixing mode aperture value range being greater than a non pixel mixing mode aperture value range used in the non pixel mixing mode.

In another preferred embodiment, the image capture apparatus of the present embodiment further includes a determination unit that determines a drive mode, wherein an aperture value range to be used is changed according to the determined drive mode.

According to an aspect of the present invention, an image capture apparatus may be able to reduce smears and adequately capture an image of a bright subject outdoors under sunny conditions without causing signal saturation as is generally demanded in an imaging apparatus even in operations where sensitivity of an image capture element is set high due to implementation of pixel mixing, for example.

### BRIEF DESCRIPTION OF THE DRAWINGS

FIG. 1 is a block diagram showing a configuration of an image capturing apparatus according to an embodiment of the present invention;

FIG. 2 is an EV line graph illustrating still image mode operations of a multi-step aperture image capture apparatus;

FIG. 3 is an EV line graph illustrating monitoring mode operations of the multi-step aperture image capture apparatus;

FIG. 4 is an EV line graph illustrating video mode operations of the multi-step aperture image capture apparatus;

FIG. 5 is an EV line graph illustrating still image mode operations of a linear aperture image capture apparatus;

FIG. 6 is an EV line graph illustrating monitoring mode operations of the linear aperture image capture apparatus;

FIG. 7 is an EV line graph illustrating video mode operations of the linear aperture image capture apparatus; and

FIG. 8 is a flowchart illustrating process steps of operations of the multi-step aperture image capture apparatus.

### DESCRIPTION OF THE PREFERRED EMBODIMENTS

In the following, preferred embodiments of the present invention are described with reference to the accompanying drawings.

According to an embodiment of the present invention, an image capture apparatus with a dedicated aperture value for video image capturing (multi-pixel addition) is provided, such a dedicated aperture value being greater than an aperture value used in still image capturing. It is noted that when an aperture value is increased, the resolution may decrease due to diffraction of light (small aperture blurring). However, since the present embodiment is related to an image capture apparatus such as a digital camera that is adapted for imaging VGA-size video images of around 3-8 million pixels, the overall influence of such a resolution decrease may be negligible. In one preferred embodiment, an ND filter may be used in order to counter such a problem.

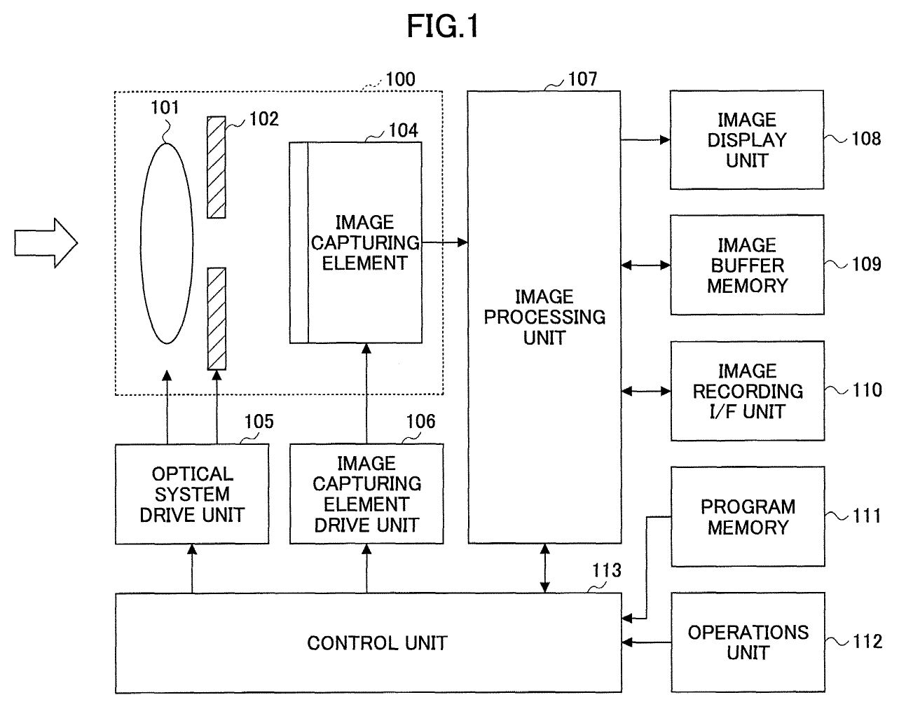

FIG. 1 is a block diagram showing an exemplary configuration of an image capture apparatus according to an embodiment of the present invention.

The illustrated image capture apparatus includes an image capturing unit 100, an optical system drive unit 105, an image capturing element drive unit 106, an image processing unit 107, an image display unit 108, an image buffer memory 109, an image recording interface unit 110, a program memory 111, an operations unit 112, and a control unit 113.

The image capturing unit 100 includes a lens 101, an aperture 102, and an image capturing element 104 that make up an image capturing optical system. The image capturing element 104 performs transfer operations for still image capturing, transfer operations for subject monitoring, and transfer operations for multi-pixel addition according to transfer pulses transmitted from the image capturing element drive unit 106.

It is noted that vertical direction pixel decimation and pixel addition may be performed within the image capturing element 104 according to the waveform (H/L timing) of the transfer signals transmitted from the image capturing element drive unit 106. In an embodiment of the present invention, horizontal direction pixel addition may also be performed within the image capturing element 104 by configuring a dedicated transfer path for horizontal direction pixel addition and controlling the image capturing element drive unit 106 to transmit a transfer waveform for performing horizontal direction pixel addition. The aperture 102 is capable of adjusting its aperture diameter to that for still image capturing, monitoring, or multi-pixel addition, for example, according to signals from the optical system drive unit 105. In one embodiment, the control unit 113 may operate as a determination unit that determines the drive mode of the image capture apparatus, namely, whether the drive mode corresponds to still image mode, monitoring mode, or video mode, for example, and the drive operations of the optical system drive unit 105 and the image capturing drive unit 106 may be controlled according to the determination result.

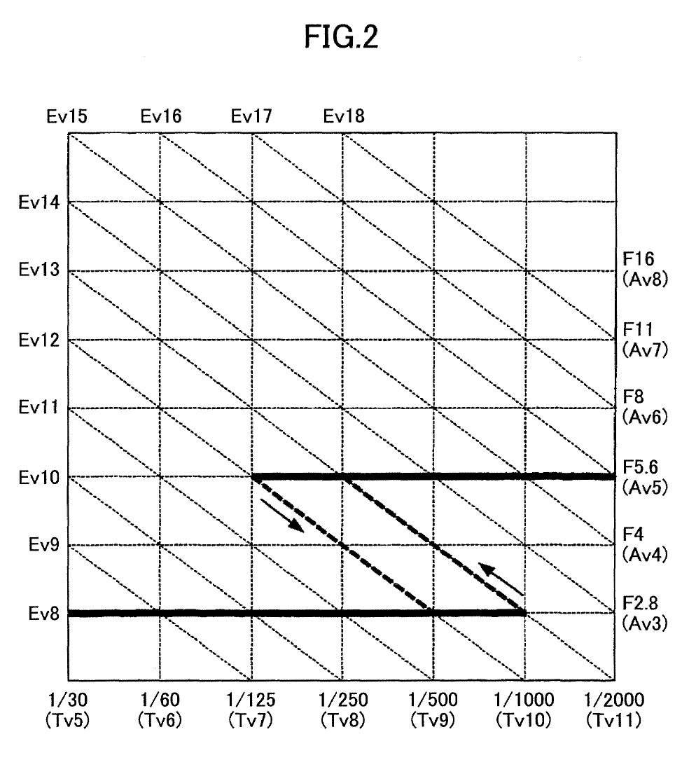

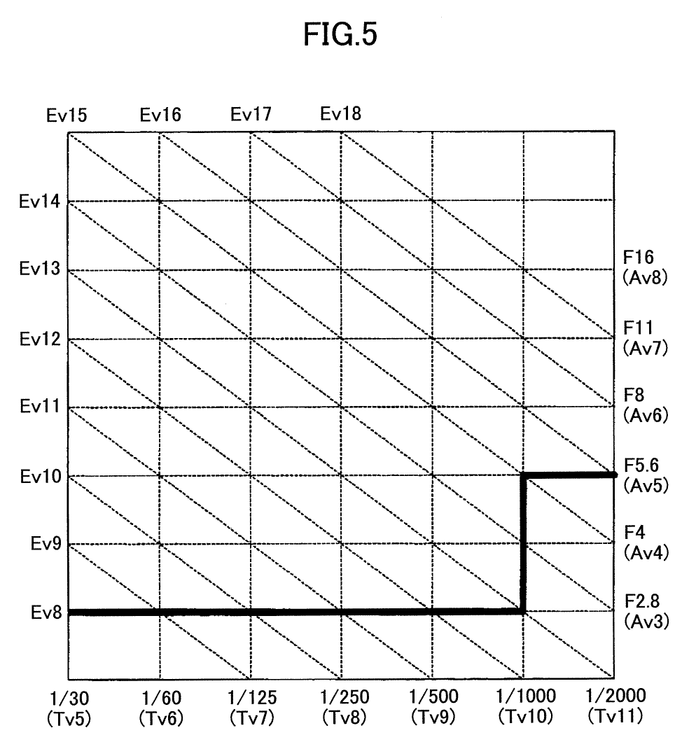

FIGS. 2-7 are EV (exposure value) line graphs illustrating control operations of image capture apparatuses according to embodiments of the present invention. Specifically, FIGS. 2-4 illustrate control operations of a multi-step aperture image capture apparatus that uses four aperture values, F2.8, F5.6, F8, and F16; and FIGS. 5-7 illustrate control operations of a linear aperture image capture apparatus using consecutively changing aperture values within an aperture value range of F2.8 to F16. In both types of image capture apparatuses, it is assumed that in still image mode with no pixel mixing, the ISO sensitivity is set to 100; in monitoring mode with two-pixel mixing, the ISO sensitivity is set to 200; and in video mode with four-pixel mixing, the ISO sensitivity is set to 400.

FIG. 2 is an EV line graph illustrating still image mode operations in the multi-step aperture scheme. As is shown in this graph, the exposure time and aperture are controlled by solid lines. In order to prevent excessive hunting due to flickering of the subject light, for example, hysteresis is created so that within the period of 1/125 sec to 1/1000 sec, the corresponding relation between the aperture and the exposure time while the exposure time changes from a longer exposure time to a shorter exposure time is different from that while the exposure time changes from a shorter exposure time to a longer exposure time. It is noted that since the resolution is given priority in the still image mode, a small aperture value of F2.8 or F5.6 are used in order to prevent small aperture blurring. In the example of FIG. 2, AE (auto exposure) control may be performed to obtain the appropriate exposure for a subject with a brightness of up to EV 16 at 1/2000 sec.

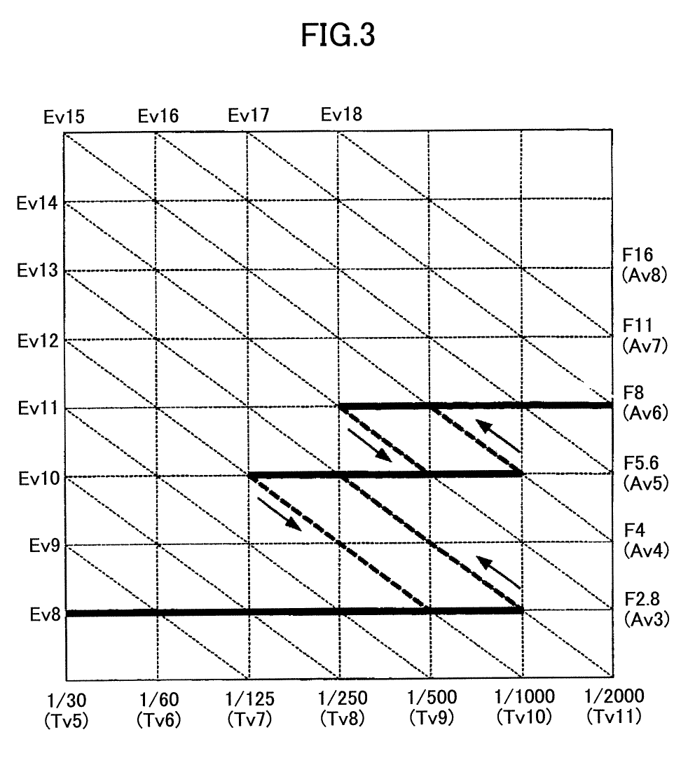

FIG. 3 is an EV line graph illustrating monitoring mode operations in the multi-step aperture scheme.

In a case where a CCD is used as the image capturing element, reduction of smears is given priority in the monitoring mode. Accordingly, exposure time that is shorter than 1/1000 sec is preferably avoided, and at 1/1000 sec, the aperture value is changed from F2.8 to F5.6, and then from F5.6 to F8. In the example of FIG. 3, AE control may be performed to obtain the appropriate exposure for a subject with a brightness of up to EV 17 (Lv 16 when rated equivalent to ISO 100) at 1/2000 sec.

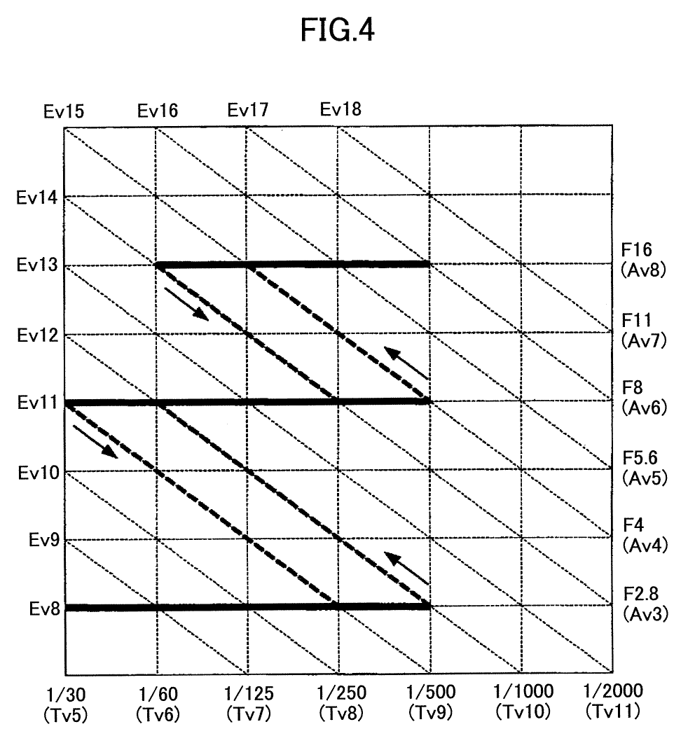

FIG. 4 is an EV line graph illustrating video mode operations in the multi-step aperture scheme.

Since the pixel addition number in this mode is double that implemented in the monitoring mode, smear properties are also doubled. Accordingly, in order to enhance measures against smearing in this mode, operations are controlled so that exposure time that is shorter than 1/500 sec may not be used. In the example of FIG. 4, AE control may be performed to obtain the appropriate exposure for a subject with a brightness of up to EV 17 (Lv 15 when rated equivalent to ISO 100). This is made possible by the use of an aperture value of F16, which is dedicated for video mode operations. In comparison, when the exposure time is controlled to be no less than 1/500 sec in an image capture apparatus that uses only three aperture values of F2.8, F5.6, and F8, AE control operations may only be capable of obtaining the appropriate exposure for a subject with a brightness of no more than Lv 13 when rated equivalent to ISO 100 so that over exposure may occur upon shooting video images outdoors under sunny conditions.

FIG. 5 is an EV line graph illustrating still image mode control operations in the linear aperture scheme. As in the example of FIG. 2, the resolution is given priority in this case, and thereby, the aperture value used in the present operations is arranged to be no more than F5.6. In this example, taking into account the mechanical control accuracy of the shutter, the aperture is controlled to change in a linear manner at 1/1000 sec rather than at 1/2000 sec.

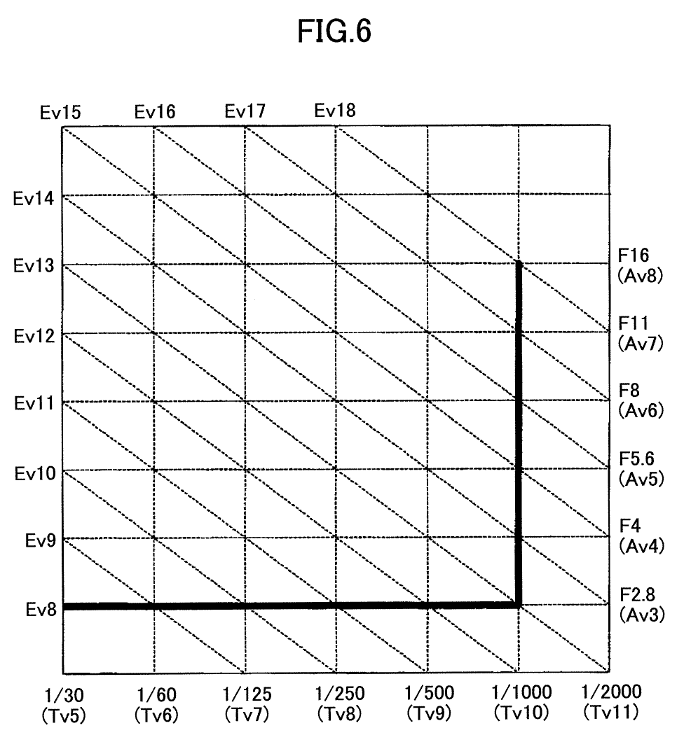

FIG. 6 is an EV line graph illustrating monitoring mode control operations in the linear aperture scheme. In this example, an exposure time shorter than 1/1000 sec is not used in order to prevent smearing, and at 1/1000 sec, the aperture is controlled to change in a linear manner from F2.8 to F16.

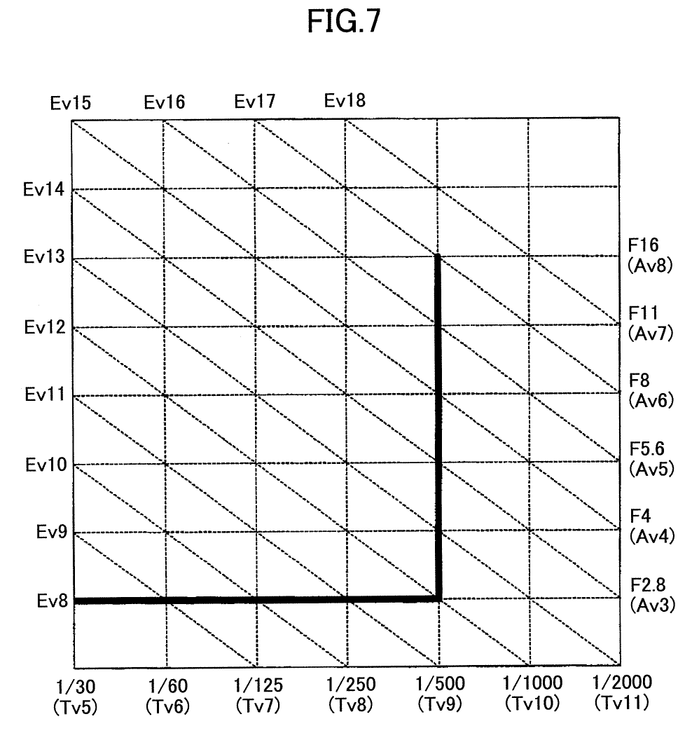

FIG. 7 is an EV line graph illustrating video mode control operations in the linear aperture scheme. In this example, the exposure time is controlled to be no less than 1/500 sec in order to prevent smearing, and at 1/500 sec, the aperture is controlled to change in a linear manner from F2.8 to F16.

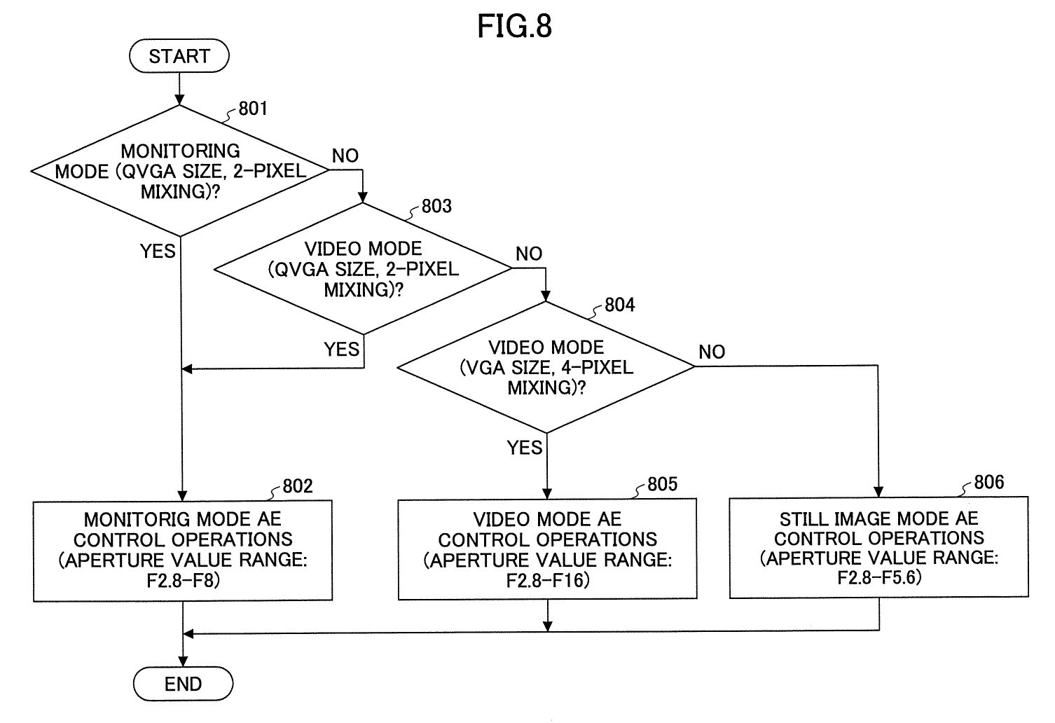

FIG. 8 is a flowchart illustrating process steps of control operations of the multi-step aperture image capture apparatus employing four aperture values, F2.8, F5.6, F8, and F16.

According to FIG. 8, in step 801, a determination is made as to whether the drive mode of the image capture apparatus corresponds to monitoring mode (QVGA size, two-pixel mixing). If it is determined that operations are in monitoring mode, the process moves on to step 802 where monitoring mode AE control operations as illustrated in FIG. 3 are performed.

On the other hand, if it is determined in step 801 that operations are not in monitoring mode (QVGA size, two-pixel mixing), the process moves on to step 803 where a determination is made as to whether the drive mode corresponds to video mode (QVGA size, two-pixel mixing). If it is determined that the operations are in video mode (QVGA size, two-pixel mixing), the process moves on to step 802 where the monitoring mode AE control operations as illustrated in FIG. 3 are performed.

On the other hand, if it is determined in step 803 that the operations are not in video mode (QVGA size, two-pixel mixing), the process moves on to step 804 where a determination is made as to whether the drive mode corresponds to video mode (VGA size, four-pixel mixing). If it is determined that the operations are in video mode (VGA size, four-pixel mixing), the process moves on to step 805 where video mode AE control operations as illustrated in FIG. 4 are performed.

On the other hand, if it is determined in step 804 that the operations are not in video mode (VGA size, four-pixel mixing), the process moves on to step 806 where still image mode AE control operations as illustrated in FIG. 2 are performed.

As can be appreciated from the above descriptions, in an image capture apparatus according to an embodiment of the present invention, the drive mode is determined, and the aperture value range is changed depending on the determined drive mode so that smears may be reduced and white-out may be prevented, for example.

Although the present invention is shown and described with respect to certain preferred embodiments, it is obvious that equivalents and modifications may occur to others skilled in the art upon reading and understanding the specification. The present invention includes all such equivalents and modifications, and is limited only by the scope of the claims.

The present application is based on and claims the benefit of the earlier filing dates of Japanese Patent Application No. 2006-066446 filed on Mar. 10, 2006, and Japanese Patent Application No. 2006-324923 filed on Nov. 30, 2006, the entire contents of which are hereby incorporated by reference.

What is claimed is:

1. An image capture apparatus, comprising:
an aperture having an adjustable aperture value;
an image capturing element; and
a drive unit that drives the image capturing element to operate in video image capturing mode and still image capturing mode; wherein
the aperture has at least one of a dedicated aperture value for the still image capturing mode and a dedicated aperture value for the video image capturing mode.

2. The image capture apparatus as claimed in claim 1, wherein
the dedicated aperture value for the video image capturing mode is greater than an aperture value used in the still image capturing mode.

3. The image capture apparatus as claimed in claim 2, wherein
a video mode aperture value range that includes the dedicated aperture value for the video image capturing mode is used when capturing a video image with a pixel size greater than or equal to a predetermine pixel size at a frame rate greater than or equal to a predetermined frame rate, the video mode aperture value range being greater than a still image mode aperture value range used in the still image capturing mode.

4. The image capture apparatus as claimed in claim 1, further comprising:
a determination unit that determines a drive mode; wherein
an aperture value range to be used is changed according to the determined drive mode.

5. An image capture apparatus, comprising:
an aperture having an adjustable aperture value;
an image capturing element; and
a drive unit that drives the image capturing element to operate in pixel mixing mode and non pixel mixing mode; wherein
the aperture has at least one of a dedicated aperture value for the pixel mixing mode and a dedicated aperture value for the non pixel mixing mode.

6. The image capture apparatus as claimed in claim 5, wherein
the dedicated aperture value for the pixel mixing mode is greater than an aperture value used in the non pixel mixing mode.

7. The image capture apparatus as claimed in claim 6, wherein
a pixel mixing mode aperture value range that includes the dedicated aperture value for the pixel mixing mode is used when pixel mixing at a pixel number greater than or equal to a predetermined pixel number is performed, the pixel mixing mode aperture value range being greater than a non pixel mixing mode aperture value range used in the non pixel mixing mode.

8. The image capture apparatus as claimed in claim 5, further comprising:
a determination unit that determines a drive mode, wherein an aperture value range to be used is changed according to the determined drive mode.
